(19) United States
(12) Patent Application Publication
(10) Pub. No.: US 2023/0302977 A1
(43) Pub. Date: Sep. 28, 2023

(54) VEHICLE ARMREST OF BIDIRECTIONALLY OPENED AND CLOSED TYPE

(71) Applicant: SHINKI INTER-MOBIL CO., LTD., Busan (KR)

(72) Inventors: Kyoung Sik KIM, Ansan-si (KR); Sang Jin JOUNG, Ulsan (KR); Hong Kil NOH, Asan-si (KR)

(21) Appl. No.: 17/851,414

(22) Filed: Jun. 28, 2022

(30) Foreign Application Priority Data
Mar. 23, 2022 (KR) 10-2022-0036062

(51) Int. Cl. B60N 2/75; B60R 7/04

(52) U.S. Cl. CPC B60N 2/793; B60R 7/04

(57) ABSTRACT

Disclosed herein is an armrest for a vehicle which can be opened and closed bidirectionally. Release buttons (14a) are mounted at both end portions of a center lid (10). Hinge pins (12a) are mounted at both sides of the front and the rear of the center lid in pairs, and are coupled to or released from hinge holes (13a) by linear movement in a transverse direction. When the release button (14a) moves inward, the hinge pin is released from the neighboring hinge hole through an elbow bracket (15) and an interlocking member (19). And the hinge pin getting out of the hinge hole cannot move outward by a hinge stopper (30).

### CROSS-REFERENCE TO REPLATED APPLICATIONS

The present application is based upon and claims the benefit of priority to Korean Patent Application No. 10-2022-0036062 filed on Mar. 23, 2022, in the Korean Intellectual Property Office, which is incorporated herein by reference in its entirety.

### BACKGROUND OF THE INVENTION

### Field of the Invention

The present invention relates to an armrest for a vehicle, and more specifically, to an armrest of a bidirectionally opened and closed type which can be selectively opened and closed forward or backward.

### Background Art

In general, a console is installed between a driver seat and a passenger seat of a vehicle. Such a console includes a storage box mounted at a lower part and an armrest for opening and closing the upper portion of the storage box. Moreover, the armrest includes side lids fixed to both sides of the storage box located at the lower part, and a center lid mounted between the side lids to be opened and closed.

In substance, the center lid of the armrest opens and closes a storage room inside the storage box. Traditionally, because the armrest is mainly used by a driver, it is configured to be opened unidirectionally from the front to the rear. However, by various requests, Korean Utility Model Application No. 20-1994-0031556 (filed on Nov. 28, 1994) and Korean Patent Application No. 10-2004-0097620 (filed on Nov. 25, 2004) proposed armrest configured to be selectively opened from the front or the rear.

Besides the above, recently, products capable of being selectively opened and closed on both sides have been disclosed. However, such conventional arts are complicated in structure and it is difficult to implement realistically. In addition, in the case that the armrest is selectively opened or closed at the front or rear, there is no countermeasures for various disadvantages that could happen in the actual use.

### SUMMARY OF THE INVENTION

Accordingly, the present invention has been made in view of the above-mentioned problems occurring in the prior art, and it is an object of the present invention to provide an armrest which is capable of being opened and closed bidirectionally.

To accomplish the above object, according to the present invention, there is provided an armrest for a vehicle which is installed on an upper portion of a storage box to open and close an open upper portion of the storage box. The armrest according to the present invention includes: side lids fixed at both sides of the upper portion of the storage box; and a center lid supported by the side lids to be opened and closed bidirectionally. Moreover, a pair of release buttons are mounted at both ends of the center lid and supported to be movable in the back-and-forth direction. Hinge pins are mounted at both sides of the front and the rear of the center lid in pairs, and are coupled to or released from hinge holes formed in both sides of the inner walls of the side lids by linear movement in a transverse direction. Additionally, when the release button moves inward, converting means releases the hinge pins from neighboring hinge holes to move the hinge pins inward. In addition, when the release button moves inward, maintaining means maintains the hinge pins, which are separated from the hinge holes and moved inward by the converting means, at the inner position without moving outward.

According to an embodiment of the present invention, the armrest further includes releasing means for releasing the maintaining means when the center lid in an open state is closed, and coupling the hinge pins to the hinge holes.

According to an embodiment of the present invention, the converting means comprises: an elbow bracket rotatably supported so that an outer end portion moves inward when the release button is pressed inward; and an interlocking member connected to the outside of the elbow bracket to move the hinge pin in a transverse direction while linearly moving in the transverse direction in conjunction with the rotation of the elbow bracket.

According to an embodiment of the present invention, the maintaining means includes a locking protrusion formed on one side of the interlocking member, and a hinge stopper having a locking arm locked with or released from the locking protrusion. When the interlocking member moves inward, the guide surface of the locking protrusion moves over the guide surface of the locking protrusion so that the locking surface of the locking protrusion is caught and fixed to the locking surface of the locking arm, and the hinge stopper is elastically supported in the direction of maintaining the locked state.

According to an embodiment of the present invention, the releasing means comprises a release arm formed at one side of the hinge stopper, and the release arm is caught to the protruding part of the side lid when the center lid is closed so that the hinge stopper is rotated to release the locked state.

According to an embodiment of the present invention, the center lid of the armrest can be opened and closed bidirectionally with respect to the side lid. Moreover, it is expected that the bidirectional opening and closing of the center lid can provide convenience to more conveniently use the console in a vehicle.

According to a specific embodiment of the present invention, it is considered that the structure for bidirectional opening and closing of the armrest can be implemented relatively simple. In other words, the hinge pin for rotating the center lid serves to function as a central shaft and to maintain the locked state, thereby simplifying the overall configuration.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating bidirectional opening and closing of an armrest according to the present invention;

FIG. 2 is a perspective view illustrating an inner structure of a center lid of the armrest according to the present invention; and

FIG. 3 is a partially perspective view illustrating a locked state and a released state of the armrest according to the present invention.

### DETAILED DESCRIPTION OF THE PREFERRED EMBODIMENT

Hereinafter, the present invention will be described in more detail with reference to the embodiment illustrated in the drawings.

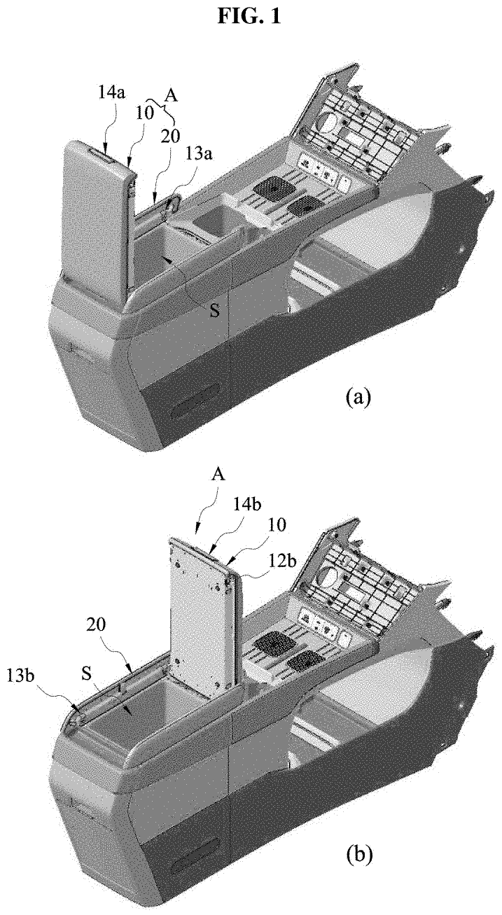

As illustrated in FIG. 1, a console installed between a driver seat and a passenger seat in a vehicle includes: a storage box S which can be referred to as a storage space; and an armrest A for opening and closing an open portion of the upper end of the storage box. The armrest A is installed on the top of the storage box S and is used to open and close the storage space of the storage box S.

Furthermore, the armrest A according to the present invention includes: a center lid 10 for opening and closing the storage box S; and a pair of side lids 20 fixed to an upper portion of the storage box S to support the opening and closing of the center lid 10. The armrest A of the present invention can more preferably make the center lid 10 selectively opened and closed in any one direction among forward and backward directions. FIG. 1(a) illustrates the center lid 10 opened backward, and FIG. 1(b) illustrates the center lid 10 opened forward.

Here, to be selectively opened and closed forward and backward substantially means to be selectively opened and closed bidirectionally. As described above, in the case that the center lid 10 of the armrest A is configured to be opened and closed bidirectionally, when any one of release buttons 14a and 14b respectively mounted on the front and rear ends of the center lid is pressed, one side coupling of the center lid 10 with respect to the side lid 20 is released and the center lid 10 is opened at a predetermined section.

For example, as illustrated in FIG. 1(a), when the center lid 10 is opened backward, front hinge pins 12a of the center lid 10 are separated from front hinge holes 13a of the side lid 10 since the release button 14a of the front is pressed, and rear hinge pins 12b are coupled to rear hinge holes 13b of the side lid 20. As illustrated in FIG. 1(b), contrariwise, the center lid 10 is opened forward.

The front hinge pins 12a and the rear hinge pins 12b are respectively arranged in pairs on both sides of the front and rear sides of the center lid 10, and are supported to move in a transverse direction. The release buttons 14a and 14b are respectively mounted at the front and the rear of the center lid 10, wherein the front release button 14a pulls a pair of the front hinge pins 12a inward in the transverse direction to approach each other so that the front hinge pins 12a are released from the front hinge holes 13a.

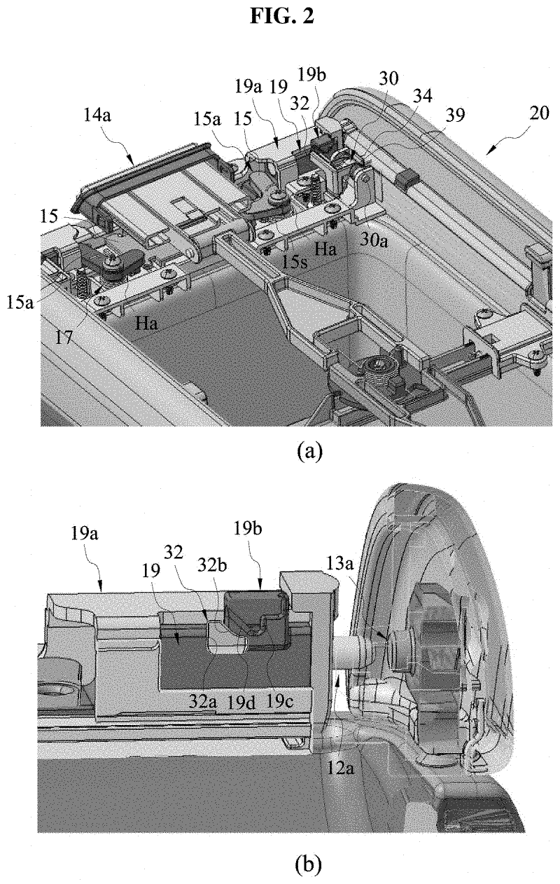

The rear release button 14b pulls a pair of the rear hinge pins 12b inward in the transverse direction to approach each other so that the rear hinge pins 12b are released from the rear hinge holes 13b. The transverse movement of the front hinge pins 12a and the rear hinge pins 12b will be described later. Next, referring to FIG. 2, a connection relationship between the release buttons 14a and 14b and the hinge pins 12a and 12b will be described.

FIG. 2 illustrates the configuration around the front hinge pin 12a, and the configuration of the rear hinge pin 12b is substantially the same. Hereinafter, the front hinge pins and the front hinge holes will be representatively described. In addition, the hinge holes are respectively formed in the inner surfaces of both side lids, and the hinge pins and the peripheral components related to the hinge pins are mounted on in the center lid.

The front release button 14a is supported to be pressed in a forward and backward direction, and the front hinge pins 12a respectively mounted at both sides thereof are supported to be linearly movable in the transverse direction, namely, in the direction at right angles to the back-and-forth direction of the release button. Here, the front release button 14a is supported to be guided in front and rear linear movement by a tubular guide 17 mounted on the center lid to surround the front release button 14a.

Furthermore, a pair of the right and left front hinge pins 12a are supported to be linearly reciprocated so as to be inserted into or get out of a pair of the front hinge holes 13a formed on the inner wall of the side lid 20. In the embodiment, a pair of the front hinge pins 12a are respectively pin-connected to an interlocking member 19 which is movably supported in the lateral direction inside the front hinge pins 12a.

In the embodiment, the front hinge pin 12a is connected to the interlocking member 19 which is movable in the lateral direction inside the tubular guide 19a fixed in the center lid 10. When the front release button 14a is pressed, a pair of elbow brackets 15 respectively connected to both sides of the front release button 14a rotate around a central axis (Ha).

In detail, the elbow bracket 15 located at the left of FIG. 2 rotates in the clockwise direction, and the elbow bracket located at the right rotates in the counterclockwise direction. Furthermore, the elbow brackets 15 are forced in one direction by springs 17, and the one direction is a direction in which an outer end portion 15a of each elbow bracket 15 rotates outward. That is, the elbow bracket 15 at the right side of FIG. 2 is elastically supported in the clockwise direction and the elbow bracket 15 of the left side is elastically supported in the counterclockwise direction.

Here, it is also possible to configure the elbow bracket 15 to be rotated by being directly connected to the front release button 14a, or to be rotated by the interlocking plate 15 interlocking in the same direction as the front release button 14a. In other words, the inner end portion of the elbow brackets is pin-connected to the left and right sides of the inside of the front release button 14a or the interlocking plate 15. Therefore, the interlocking plate 15 linearly moves in the same direction according to the linear movement of the front release button 14a which is pressed backward.

Due to the linear movement of the interlocking plate 15, the elbow bracket 15 rotates. According to the rotation of the elbow bracket 15, the outer end portions 15a move inwardly, namely, in the direction that the outer end portions 15a approach each other. Therefore, the interlocking member 19 pin-connected to the outer end portion 15a of the elbow bracket 15 moves inward. Since the interlocking member 19 is connected to the front hinge pin 12a, when a pair of the interlocking members 19 move inward, a pair of the front hinge pins 12a also move inward.

When a pair of the front hinge pins 12a move inward, the coupling between the front hinge pins 12a and the front hinge holes 13a formed on the inner wall of the side lid 20 is released. When the front hinge pin 12a is released from the hinge hole 52a, the center lid 10 can be moved with respect to the substantially fixed side lid 20. Moreover, while the front hinge pin 12a is separated from the front hinge hole 13a, the rear hinge pin 12b is coupled to the rear hinge hole 13b.

Therefore, the center lid 10 can be opened from the front to the rear based on the rear hinge pin 12b. On the contrary, when the rear hinge pin 12b is released from the rear hinge hole 13b and the front hinge pin 12a is coupled to the front hinge hole 13a, the center lid 10 can be opened from the rear to the front. In fact, the configuration for coupling and releasing the hinge pins 12a and 12b and the hinge holes 13a and 13b is the same as described above.

Furthermore, a pair of the hinge pins 12a moved inward should maintain a stopped state inside. When the center lid 10 is closed again in the state in which the hinge pin 12a stops inside, the hinge pin 12a moves outward again to be coupled to the hinge hole 13a. In other words, the state in which the hinge pin is released from the hinge hole when the release buttons 14a and 14b are pressed must be maintained during the time that the center lid 10 is open. After that, when the center lid is closed, the hinge pin is coupled to the hinge hole again.

As illustrated in FIG. 2, as described above, the hinge pin 12a is interlocked with the interlocking member 19. A locking protrusion 19b having a shape protruding forward is formed on the interlocking member 19. The locking protrusion 19b includes a locking surface 19c formed on the outer face, and a guide surface 19d formed on an inclined surface or a smooth curved surface formed on the inner face.

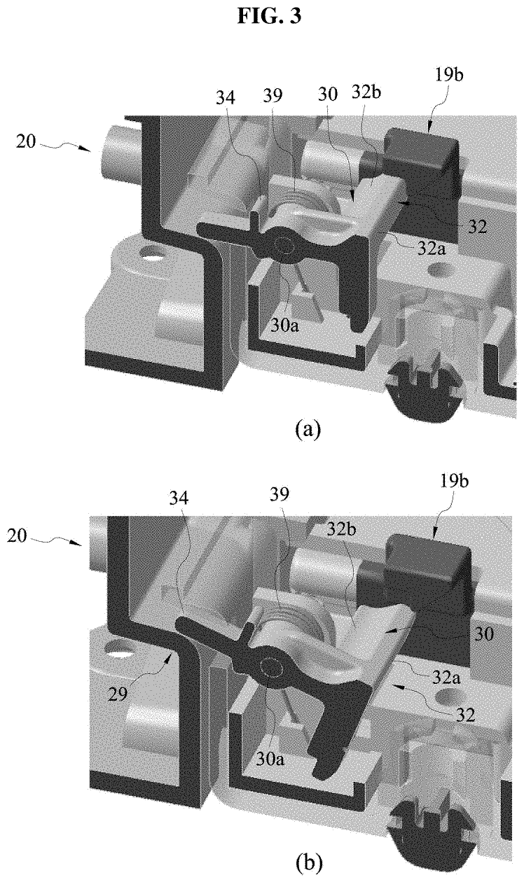

In addition, as illustrated in FIGS. 2 and 3, a hinge stopper 30 is mounted adjacent to the interlocking member 19. The hinge stopper 30 is rotatably supported around a support shaft 30a of the back-and-forth direction, and includes a locking arm 32 extending toward the locking protrusion 19b. Additionally, the hinge stopper 30 also includes a release arm 34 extending outward toward the side lid 20.

The locking arm 32 has a guide surface 32b formed as an inclined surface or a curved surface and a vertically locking surface 32a formed inside the guide surface 32b. The hinge stopper 30 is supported by a spring (torsion spring) 39 so that the locking surface 32a of the locking arm 32 and the locking surface 19c of the locking protrusion 19b always maintain the locked state. That is, when the hinge pin 12a is pulled out from the hinge hole 13a by the above-described operation, the interlocking member 19 also moves inward. In this instance, the interlocking member 19 is guided by a tubular guide 19a to move linearly.

Moreover, the locking arm 32 of the hinge stopper 30 and the locking protrusion 19b of the interlocking member 19 are disposed to be adjacent to each other. Therefore, when the guide surface 19d of the locking protrusion 19b applies power while getting in contact with the guide surface 32b of the locking arm 32 in accordance with the inward movement of the interlocking member 19, the hinge stopper 30 is rotated around the support shaft 30a. In this instance, the guide surface 19d of the interlocking member 19 passes over the guide surface 32b of the locking arm 32.

In addition, the rotation of the hinge stopper 30 having the locking arm 32 is substantially made against the force of the spring 39. When the locking protrusion 19 passes over the locking arm 32, the locking arm 32 rotates in the opposite direction by the elastic force of the spring 39, and the locking surface 19c of the locking protrusion 19b is caught by the locking surface 32a of the locking arm 32.

The locking surface 19c and the locking surface 32a are vertical surfaces which can be caught to each other, and the locking arm 32 of the hinge stopper 30 receives an elastic force upward to maintain the locked state by the spring 39. Therefore, the locking surface 19c of the locking protrusion 19 and the locking surface 32a of the locking arm 32 maintain the locked state without any external force.

Therefore, the hinge pin 12a gets out of the hinge hole 13a and maintains the inwardly moved state, which means that the center lid 10 is maintained in the opened state. The hinge pin 12a is moved inward to maintain a state that the hinge pin 12a is not coupled to the hinge hole, so that the center lid 10 can be closed. FIG. 3(a) illustrates the state in which the hinge pin 12a is separated from the hinge hole to open the center lid 10.

In order to close the center lid 10 in the open state, the center lid 10 should be lowered downward. When the center lid descends downward, the hinge stopper 30 is also lowered downward. When the center lid 10 is lowered to an approximately horizontal state, the release arm 34 of the hinge stopper 30 is bumped against a protruding portion 29 of the side lid 20 so that the hinge stopper 30 rotates. The rotational direction of the hinge stopper is the direction in which the locking arm 32 descends, as illustrated in FIG. 3(b).

When the locking arm 32 descends down, the locking surface 32b is lowered to release the locked state of the locking arm 32 and the interlocking member 19. When the locked state is released, the interlocking member 19 can move outward. Referring to FIG. 2, the outer end portion 15a of the elbow bracket 15 pin-connected to the interlocking member 19 is always elastically supported by the spring 15s in the outward direction, namely, in the direction of the interlocking member or the hinge pin.

Therefore, when the locked state between the locking arm 32 of the hinge stopper 30 and the locking protrusion 19b of the interlocking member 19 is released, the interlocking member 19 moves outward by the elastic restoring force of the spring 15S. The outward movement of the interlocking member 19 substantially moves the hinge pin 12a in the outward direction to make the hinge pin 12a enter the hinge hole 13a. In other words, when the center lid 10 moves downward to close, the locked state between the locking arm 32 and the locking protrusion 19b is released, and the hinge pin 12a enters the hinge hole 13a.

Till now, referring to FIGS. 2 and 3, the present invention is described with respect to one hinge pin. In fact, the relevant structure and operation of the hinge pin 12a and the hinge hole 13a are applied to a pair of front hinge pins and a pair of rear hinge pins. Therefore, when a pair of the front hinge pins are released from the front hinge holes, the center lid is opened from the front to the rear around the rear hinge pin as a central axis.

It is obvious to a person skilled in the art that various modifications and changes can be made within the scope of the basic technical idea of the present invention. In addition, it should be appreciated that the protective scope of the present invention is interpreted based on the claims set forth.

What is claimed is:

1. An armrest for a vehicle, which is installed on an upper portion of a storage box to open and close an open upper portion of the storage box and includes side lids fixed at both sides of the upper portion of the storage box and a center lid supported by the side lids to be opened and closed bidirectionally, the armrest comprising:
a pair of release buttons mounted at both ends of the center lid and supported to be movable in the back-and-forth direction;
hinge pins mounted at both sides of the front and the rear of the center lid in pairs, and coupled to or released from hinge holes formed in both sides of the inner walls of the side lids by linear movement in a transverse direction;
converting means for releasing the hinge pins from neighboring hinge holes to move the hinge pins inward when the release button moves inward; and
maintaining means for maintaining the hinge pins, which are separated from the hinge holes and moved inward by the converting means, at the inner position without moving outward.

2. The armrest according to claim 1, further comprising:
releasing means for releasing the maintaining means when the center lid in an open state is closed, and coupling the hinge pins to the hinge holes.

3. The armrest according to claim 1, wherein the converting means comprises: an elbow bracket rotatably supported so that an outer end portion moves inward when the release button is pressed inward; and an interlocking member connected to the outside of the elbow bracket to move the hinge pin in a transverse direction while linearly moving in the transverse direction in conjunction with the rotation of the elbow bracket.

4. The armrest according to claim 3, wherein the maintaining means comprises a locking protrusion formed on one side of the interlocking member, and a hinge stopper having a locking arm locked with or released from the locking protrusion, and when the interlocking member moves inward, the guide surface of the locking protrusion moves over the guide surface of the locking protrusion so that the locking surface of the locking protrusion is caught and fixed to the locking surface of the locking arm, and the hinge stopper is elastically supported in the direction of maintaining the locked state.

5. The armrest according to claim 4, wherein the releasing means comprises a release arm formed at one side of the hinge stopper, and the release arm is caught to the protruding part of the side lid when the center lid is closed so that the hinge stopper is rotated to release the locked state.
